(19) United States
(12) Patent Application Publication
(10) Pub. No.: US 2002/0103739 A1
(43) Pub. Date: Aug. 1, 2002

(54) METHOD AND SYSTEM FOR AGGREGATING MULTIPLE MARKETPLACES

(76) Inventors: Samuel Dinkin, Austin, TX (US); Stephen J. Boies, Mahopac, NY (US); David P. Greene, Ossining, NY (US); William Grey, Millwood, NY (US); Philip Shi-Lung Yu, Chappaqua, NY (US); Paul Andrew Moskowitz, Yorktown Heights, NY (US)

Correspondence Address: MORGAN & FINNEGAN, L.L.P., 345 Park Avenue, New York, NY, 10154, US

(21) Appl. No.: 09/770,874

(22) Filed: Jan. 26, 2001

(51) Int. Cl. G06F 17/60

(52) U.S. Cl. 705/37

(57) ABSTRACT

A method and system for aggregating marketplaces for the purpose of fulfilling a supply or service need is disclosed. The method and system optimizes the ordering of supplies or services through an analysis consistent with predetermined criteria. By exploring many possible marketplaces to fulfill a particular need, the present invention can determine which method of fulfillment most effectively fulfills the particular need.

Similar scenarios exist with regard to other products and services as well. However, most consumers, and often sellers of products and services, are unaware of existing markets of similar and equivalent products and services. Because of this ignorance, some consumers often pay an unnecessarily higher price for products and services while some sellers often sell their available products and services for substantially less than they might be worth in a different market.

Prior art methods and systems for fulfilling supply and service needs have been relatively simple. Bids are accepted from suppliers which are potentially capable of fulfilling a buyer's particular needs, or vice versa. The lowest, or highest bid is then accepted unless that bidder has been determined by past experience to be too unreliable. However, prior art methods and systems for fulfilling supply and service needs have not been concerned with similar or equivalent products and services. Therefore, though this method does fulfill the needs of a consumer, it is not always the most efficient and cost effective manner in which to achieve fulfillment. Therefore, there exists a need for an improved method for optimizing the efficiency and cost effectiveness of need fulfillment.

### SUMMARY OF THE PRESENT INVENTION

The present invention utilizes this disparity among markets, to optimize for a particular consumer or seller, the fulfillment of needs. By doing so, the present invention overcomes the shortcomings of the prior art mentioned above.

By exploring many markets to fulfill a particular need, the present invention can determine which market most effectively fulfills the particular need. In determining the possible markets, the present invention also considers similar and equivalent products and services.

Further, the present invention encourages markets throughout the world seeking to transact with consumers and sellers which utilize the present invention, to alter their own prices and business methods. These changes have the effect of increasing competition among the various markets, and thus benefiting consumers and sellers utilizing the system or method.

### BRIEF DESCRIPTION OF THE DRAWINGS

A better understanding of the present invention will be had upon reference to the following detailed description, when read in conjunction with the accompanying drawings, in which:

FIG. 1 is a chart illustrating data stored for fulfilling supply and service needs in accordance with the present invention;

FIG. 2 illustrates a preferred embodiment of a system for aggregating multiple marketplaces in accordance with the present invention;

FIGS. 3 and 4 illustrate embodiments of systems for aggregating multiple marketplaces in accordance with the present invention; and

FIG. 5 illustrates an embodiment of the process for fulfillment of service and supply needs through the aggregation of multiple markets in accordance with the present invention.

### DETAILED DESCRIPTION

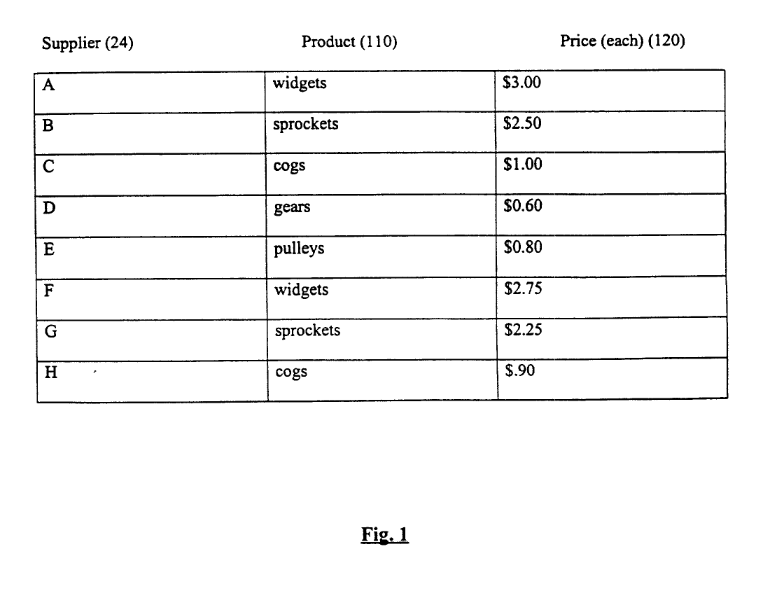

With reference first to FIG. 1, a chart illustrating a typical list of bids or prices from suppliers is shown. It should be noted that the terms supplier and seller are used herein interchangeably and refers to the supplier, seller or offeror of goods and/or services associated with the system and processes described herein. When a supply or service need (hereinafter referred to as “need”) is communicated to suppliers, they customarily submit a bid, an offer for fulfilling such needs. Additionally, standard prices may be published or advertised by such suppliers. Buyers may bid in a similar manner for a limited commodity. The large disparity in price reflects the differences in price common among different markets.

A particular need may be fulfilled by more than one product or service. The supply need illustrated by the chart of FIG. 1 may reflect a buyer's request for a quantity of widgets. Upon investigation by one embodiment of the present invention, it may be revealed that sprockets are equivalent to widgets but are sold in different markets. Further, it may become apparent that two cogs, gears, or pulleys may be substituted for a sprocket in certain applications, and these parts are each sold in a distinct market. The price 120, represents the total price charged by a particular supplier for providing a particular part or product 110.

A typical company utilizing a prior art method of fulfilling its needs might purchase its needed supplies or services from a supplier such as Supplier A in the situation illustrated by FIG. 1 at a price of $3 each widget. If the company searched for a lower price within the market of widget manufacturers, the company might discover Supplier F and choose to employ Supplier F at a cost of $2.75 for each widget.

However, the present invention searches for a more cost effective solution by analyzing the data of FIG. 1 as well as other pertinent information. For example, let us first suppose that neither gears nor pulleys are suitable for the buyer's intended application despite their similarity to widgets, possibly because of the quality requirements of the buyer. The method and system may then review offerings among other markets for a suitable part (or service) Such a search may reveal that Supplier H is offering cogs—a part which is a suitable replacement for buyer's widgets. The present invention may further determine that employing Supplier H is most cost effective at a savings of 40% over Supplier A. Further, the inclusion of multiple marketplaces may tend to improve the quality and reliability of the transacted for product or service.

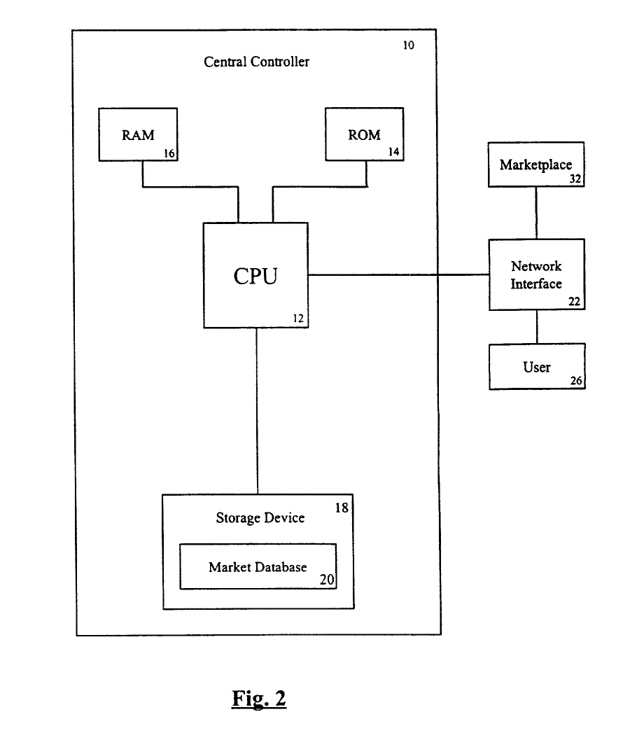

Referring now to FIG. 2, the system architecture of a central controller according to one embodiment of the system of the present invention is shown. In that embodiment, the system and method includes a central controller 10. The central controller 10 is a conventional general purpose computer, including a central processing unit (“CPU”) 12, read-only memory (“ROM”) 14, and random access memory (“RAM”) 16. The central controller also includes a storage device 18, for example one disk or more disk drives.

The CPU 12 executes program code stored in one or more of ROM 14, RAM 16, and storage device 18 according to conventional data processing techniques to carry out the functions and acts described in connection with the central controller 10. CPU 12 preferably comprises at least one high-speed digital data processor adequate to execute program modules for selecting and executing purchases.

The CPU 12 preferably comprises a conventional microprocessor such as an Intel® Pentium Processor. CPU 12 is electronically coupled with each of the central controller's 10 other elements.

The storage device 18 may include a market database 20. The CPU 12 maintains and accesses data stored in the market database 20 and analyzes the information stored in this database. The market database 20 may include information regarding terms of art, similar and equivalent products and services, individual suppliers and buyers, and distinct markets.

The central controller 10 may also be connected to a network interface 22, which allows the elements of the central controller 10 to communicate with entities outside of the utilizing company. The network interface 22 could be a phone, fax, wireless communication device, or the like. The network interface 22 is in communication with the markets 32, whose information is stored in the supplier database 20 and a user 26. It should be noted that the user 26 may be a buyer or seller (or supplier) of goods and/or services associated with the systems and methods described herein. Through its network interface 22, the present embodiment can order particular supply and service needs to be fulfilled.

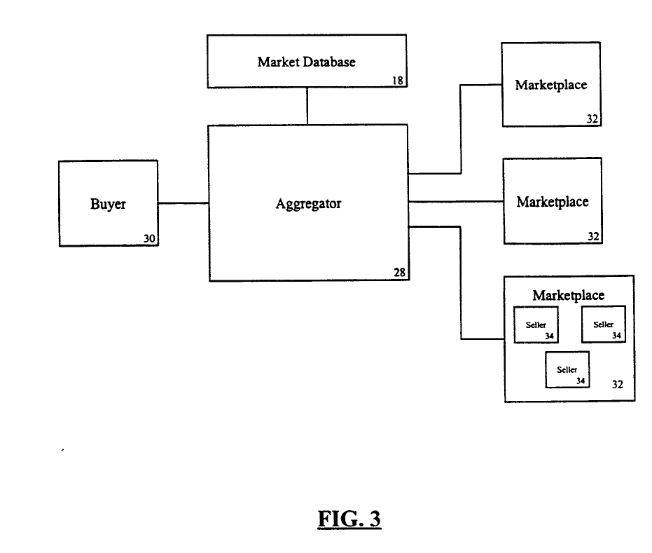

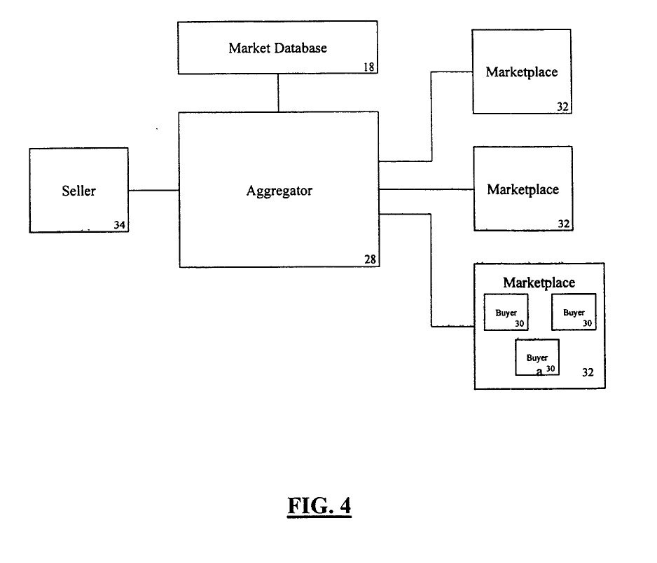

Referring to FIGS. 3 and 4, the structure of functional units of a system embodying the present invention is shown. The aggregator 28, embodied in the central controller 10, is in communication with a number of marketplaces 32. Each marketplace contains a number of buyers 30 or sellers 34.

An individual buyer 30 as illustrated in FIG. 3, or alternatively an individual seller 34 as illustrated in FIG. 4 communicates a request to the aggregator 28. The aggregator 28 then retrieves information pertinent to that particular request from the market database 20. The aggregator utilizes this information in order to send requests to sellers 34 or buyers 30, whichever is appropriate, in suitable marketplaces 32 for bids.

The aggregator 28 analyzes all of the data it has available to suggest a course of action for the individual buyer 30 as in FIG. 3 or seller 34 as in FIG. 4. The aggregator 28 then continues to facilitate the transaction between the individual buyer 30 (FIG. 3) or seller 34 (FIG. 4).

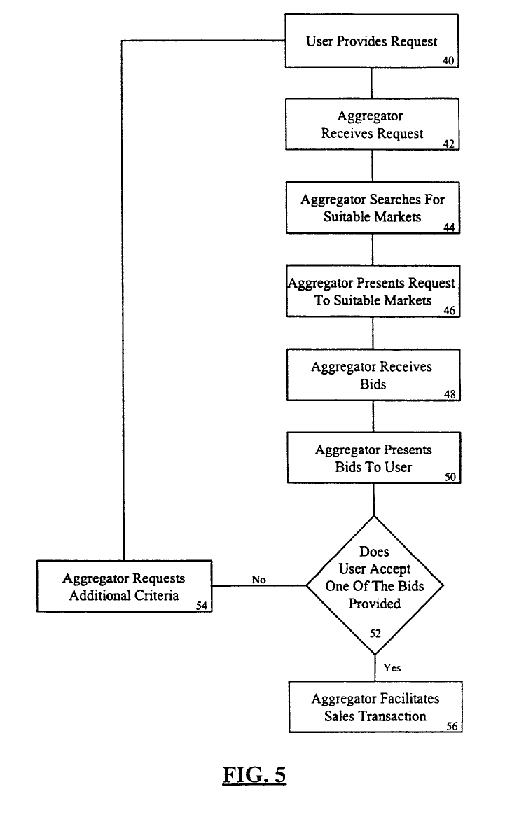

Referring to FIG. 5, the process of fulfilling a need through the aggregation of multiple marketplaces according to one embodiment of the system and method of the present invention is illustrated. The aggregation process begins upon a request being provided by the user 26 (Step 40). This request may reflect the user's desire to acquire some product or service, or to sell a particular product or service. Upon the request being made, the processor 12 of the present embodiment continues to step 42, where it receives a user's input to describe the particular request to be fulfilled.

The search is then performed by aggregator 28, at step 44. The communication between the aggregator 28 and the user 26 is facilitated by the network interface 22. The request made by the user 26 may be inputted to the aggregator 28 through various means well known to those skilled in the art. However, in one embodiment of the present invention, the request is made in a standardized, predetermined manner so as to facilitate the aggregation process of the present invention. The search performed by the aggregator 28 may entail searching for similar and equivalent products or services as those demanded by the request. The aggregator 28 relies on the market database 20 for this purpose, to determine which products and services are similar to one another. Further, the market database 20 may contain information regarding the particular user 26, as well as various buyers 30 and sellers 34. This information can thus be used by the aggregator 28 to narrow its search for suitable markets 32, buyers 30, and sellers 34. In one embodiment, a database may be accessed which allows the aggregator 28 to search among different synonyms and other predetermined algorithms to identify similar products within or among different markets. One such algorithm may be searching among related standard industry codes (SIC) to identify other suitable products and/or services that may meet the buyer's 30 requirements.

Next, at step 46, the aggregator 28 presents the request made by the user 26 to the component buyers 30 or sellers 34 that form various markets 32. This presentation too may be made in a predetermined, standardized form so as to facilitate the individual buyers' 30 or sellers' 34 analysis of the request.

The aggregator 28 then waits at step 48 for bids or proposals from the buyers 30 or sellers 34 of the markets 32 selected at step 44. The bidding may be conducted by a number of known processes such as an open auction, sealed auction, negotiation proposal, setting and posting a price, or offering an exchange. The aggregator 28 receives the bids or proposals, in a standardized form well known to those skilled in the art in a preferred embodiment of the present invention. Such a form may be required of the buyers 30 and sellers 34 who wish to participate in the system of the present invention.

The aggregator 28 then processes these bids and proposals that it has received over a designated allotted time period, and presents them to the user 26 at step 50. These presentations as well may be in a standardized form reflecting such quantifiable factors which may include price, perceived quality, type of product or service, perceived reliability, availability, and time required for fulfillment.

At step 52, after the user 26 is provided with all of the necessary and relevant information from the proposals, the user 26 may choose whether to accept one or more of the proposals. If the user 26 does not find any of the proposals to be satisfactory, the processor 12 branches to step 54, where the aggregator 28 requests that the user 26 provide additional criteria for its request or rephrases its previous request. The processor 12 then begins the aggregation process again at step 40.

Conversely, if the user 26 chooses to accept one or more of the proposals provided, the processor 12 moves to step 56. At step 56, the aggregator facilitates any sales transactions to be conducted between the user 26 and buyers 30 or sellers 34. The facilitation by the aggregator 28 may be beneficial to the user 26, as the identity of the user 26 can thus be concealed until such time as the user 26 desires to be known.

It will be apparent to those skilled in the art that various modifications and variations can be made in the system and processes of the present invention without departing from the spirit or scope of the invention. Thus, it is intended that the present invention cover the modifications and variations of this invention provided they come within the scope of the appended claims and their equivalents. In this context, equivalents means each and every implementation for carrying out the functions recited in the claims, even if not explicitly described herein.

I claim:

1. A method for fulfilling at least one need comprising:
receiving at least one request;
identifying a plurality of markets that are capable of fulfilling said request;
requesting at least one offer to fulfill said request from at least one entity within said identified markets; and
communicating at least a portion of said offers to a party making the request.

2. The method of claim 1, wherein markets capable of fulfilling similar needs are identified.

3. The method of claim 1, further comprising facilitating a transaction between said party making the request and at least one of said entities within said identified markets.

4. The method of claim 3 wherein the identity of said party making the request is withheld for a period of time from said entities within said identified markets.

5. The method of claim 1 wherein said offers are made through an open auction.

6. The method of claim 1 wherein said offers are made through a sealed auction.

7. The method of claim 1 wherein said offers are made through a series of negotiations.

8. The method of claim 1 wherein said offers are made through a posting of a price.

9. The method of claim 1 wherein said offers are offers for exchange of goods or services.

10. The method of claim 1 wherein said communication of at least a portion of said offers includes the offered prices.

11. The method of claim 1 wherein said communication of at least a portion of said offers includes the perceived quality of the goods or services being offered.

12. The method of claim 1 wherein said communication of at least a portion of said offers includes the type of goods or services being offered.

13. The method of claim 1 wherein said communication of at least a portion of said offers includes the perceived reliability of said entities within said identified markets.

14. The method of claim 1 wherein said communication of at least a portion of said offers includes the perceived optimum solution to the fulfillment of said request.

15. The method of claim 1 wherein said identification is accomplished in part by translating terms of art contained within said request.

16. A system for fulfilling at least one need comprising:
means for receiving at least one request;
means for identifying a plurality of markets that are capable of fulfilling said request;
means for requesting at least one offer to fulfill said request from entities within said identified markets; and
means for communicating at least a portion of said offers to a party making the request.

17. The system of claim 16, further comprising means for identifying markets capable of fulfilling similar needs to that requested.

18. The system of claim 16, further comprising means for facilitating a transaction between said party making the request and at least one of said entities within said identified markets.

19. The system of claim 18 further comprising means for withholding the identity of said party making the request for a period of time from said entities within said identified markets.

20. The system of claim 16 further comprising means for said offers to be made through an open auction.

21. The system of claim 16 further comprising means for said offers to be made through a sealed auction.

22. The system of claim 16 further comprising means for said offers to be made through a series of negotiations.

23. The system of claim 16 further comprising means for said offers to be made through a posting of a price.

24. The system of claim 16 wherein said offers are offers for exchange of goods or services.

25. The system of claim 16 wherein said means for communicating at least a portion of said offers includes the offered prices.

26. The system of claim 16 wherein said means for communicating at least a portion of said offers includes the perceived quality of the goods or services being offered.

27. The system of claim 16 wherein said means for communicating at least a portion of said offers includes the type of goods or services being offered.

28. The system of claim 16 wherein said means for communicating at least a portion of said offers includes the perceived reliability of said entities within said identified markets.

29. The system of claim 16 wherein said means for communicating at least a portion of said offers includes the perceived optimum solution to the fulfillment of said request.

30. The method of claim 16 further comprising means for said identification to be accomplished in part by translating terms of art contained within said request.

31. A need fulfillment optimization system comprising:
a memory for storing data comprising market profiles; and
a central processing unit coupled to said memory, said central processing unit being capable of:
receiving at least one request;
identifying a plurality of markets that are capable of fulfilling said request;
requesting at least one offer to fulfill said request from at least one entity within said identified markets; and
communicating at least a portion of said offers to a party making the request.

32. The system of claim 31, wherein said processing unit is further capable of identifying markets capable of fulfilling similar needs.

33. The system of claim 31, wherein said processing unit is further capable of facilitating a transaction between said party making the request and at least one of said entities within said identified markets.

34. The system of claim 33 wherein said processing unit is further capable of withholding the identity of said party making the request for a period of time from said entities within said identified markets.

35. The system of claim 31 wherein said offers are made through an open auction.

36. The system of claim 31 wherein said offers are made through a sealed auction.

37. The system of claim 31 wherein said offers are made through a series of negotiations.

38. The system of claim 31 wherein said offers are made through a posting of a price.

39. The system of claim 31 wherein said offers are offers for exchange of goods or services.

40. The system of claim 41 wherein said communication of at least a portion of said offers includes the offered prices.

41. The system of claim 31 wherein said communication of at least a portion of said offers includes the perceived quality of the goods or services being offered.

42. The system of claim 31 wherein said communication of at least a portion of said offers includes the type of goods or services being offered.

43. The system of claim 31 wherein said communication of at least a portion of said offers includes the perceived reliability of said entities within said identified markets.

44. The system of claim 31 wherein said communication of at least a portion of said offers includes the perceived optimum solution to the fulfillment of said request.

45. The system of claim 31 wherein said identification is accomplished in part by translating terms of art contained within said request.

46. A computer program for fulfilling at least one need comprising:
code for receiving at least one request;
code for identifying a plurality of markets that are capable of fulfilling said request;
code for requesting at least one offer to fulfill said request from at least one entity within said identified markets; and
code for communicating at least a portion of said offers to a party making the request.

47. The computer program of claim 46, further comprising code for identifying markets capable of fulfilling similar needs.

48. The computer program of claim 46, further comprising code for facilitating a transaction between said party making the request and at least one of said entities within said identified markets.

49. The computer program of claim 48 further comprising code for withholding the identity of said party making the request for a period of time from said entities within said identified markets.

50. The computer program of claim 46 wherein said offers are made through an open auction.

51. The computer program of claim 46 wherein said offers are made through a sealed auction.

52. The computer program of claim 46 wherein said offers are made through a series of negotiations.

53. The computer program of claim 46 wherein said offers are made through a posting of a price.

54. The computer program of claim 46 wherein said offers are offers for exchange of goods or services.

55. The computer program of claim 46 wherein said communication of at least a portion of said offers includes the offered prices.

56. The computer program of claim 46 wherein said communication of at least a portion of said offers includes the perceived quality of the goods or services being offered.

57. The computer program of claim 46 wherein said communication of at least a portion of said offers includes the type of goods or services being offered.

58. The computer program of claim 46 wherein said communication of at least a portion of said offers includes the perceived reliability of said entities within said identified markets.

59. The computer program of claim 46 wherein said communication of at least a portion of said offers includes the perceived optimum solution to the fulfillment of said request.

60. The computer program of claim 46 further comprising code for said identification to be accomplished in part by translating terms of art contained within said request.
